(19) United States
(12) Patent Application Publication
(10) Pub. No.: US 2007/0108684 A1
(43) Pub. Date: May 17, 2007

(54) Adjustaclamp

(76) Inventor: Robert M. Webb, Alexandria, VA (US)

Correspondence Address: Mr. Robert M. Webb, 5425 Rickenbacker Avenue, Alexandria, VA, 22304, US

(21) Appl. No.: 11/280,322

(22) Filed: Nov. 17, 2005

(51) Int. Cl. B25B 1/14

(52) U.S. Cl. 269/228

(57) ABSTRACT

A toggle clamp and spindle assembly. The spindle assembly can be adjusted both vertically and horizontally without the use of tools. A collar forms part of the spindle assembly and is mounted on the channel walls of the toggle clamp. A collar locking mechanism mounted fixes the horizontal position of the spindle assembly relative on the channel walls. An upper end adjustment handle fixed to the spindle is used to vertically adjust the position of the spindle and a lower work piece engaging grommet.

### BACKGROUND OF THE INVENTION

The present invention relates generally to work piece holding devices and more particularly to a toggle clamp type holding device. Toggle clamps are well known and are used to hold a work piece to a working surface in order that procedures may be performed on the work piece stock. Historically, toggle clamps can be adjusted both vertically or horizontally relative to the work surface by using a single procedure that is virtually identical for the adjustment of each axis of adjustment, i.e., by loosening and tightening two separate nuts, one located over and another located under an elongated central channel. Thus, adjustments in either the vertical or horizontal axis may necessitate adjustment in the other axis. These nuts may be on a vertically disposed threaded spindle or bolt. The present invention greatly simplifies both the number of parts required and the vertical and horizontal adjustment for the holding device within the toggle channel.

### DESCRIPTION OF THE PRIOR ART

Toggle clamps of various descriptions are known in the prior art. U.S. Pat. No. 6,394,712 to Weinstein et al. describes a clamp having an adjustable spindle 70 which extends through two separate holders 31,42. In the patent (U.S. Pat. No. 6,595,507) to Dykstra two split members are disclosed with a thumb screw. By adjusting nuts the member 58 may be vertically adjusted. U.S. Pat. No. 5,924,685 to Webb was the first adjustable toggle clamp to provide for the horizontal adjustment along the toggle clamp channel separate from the adjustment along the vertical axis, relative to a work piece on a work surface. Webb teaches a vertical adjustment may be made by turning a handle installed on the end of a spindle assembly, relative to a work pieces on a work surface. The turning of the handle turns a threaded shaft spindle assembly relative to a work surface by engaging the internal threads of a collar, internal to the toggle clamp channel, with the threaded shaft spindle further tuning the other end, which end employs a working pieces engaging member, usually a grommet. Webb further teaches a separate horizontal adjustment of a two piece split collar that extends to the top and bottom surfaces of the toggle channel. In the prior Webb invention, only the vertical adjustment is made manually, i,e., without the use of any tools or tool-less. The U.S. Pat. No. 6,905,116 to Cummines et al. discloses a toggle clamp having a spindle assembly with a plunger and a spindle. The present invention greatly reduces the number of parts necessary for the vertical adjustment of the toggle assembly which simplification overcomes an apparent weakness of the earlier cited Webb invention. Herein, the vertical adjustment is accomplished by manually turning a handle attached to the spindle assembly. This spindle assembly has a collar with a spindle extending through the collar with the collar extending around the toggle clamp channel. In the prior Webb invention the horizontal adjustment of the spindle assembly is made by loosening and then tightening a nut with a wrench or similar tool, which nut engages an external threaded surface of the internal collar that extends below the bottom surface of the toggle clamp's elongated channel. In contrast, the present invention simplifies the horizontal adjustment of the toggle clamp assembly by providing for the sliding of an external collar that surrounds the central channel walls. This slidable collar may be fixed in position by manually turning a locking mechanism, such as a thumb screw. In this way, both the vertical and adjustment of the toggle assembly are tool-less or manual and each adjustment is separate from the other.

### SUMMARY OF THE INVENTION

This invention relates to an adjustable holding device for a work piece that is placed on a reference work surface. The holding device may be adjusted either vertically or horizontally, or both, with respect with working surface. Adjustments are made vertically by a single spindle handle or horizontally by a collar mounted locking mechanism. Both the spindle and the collar are mounted to each other with the collar being slidably along the channel walls of the toggle clamp.

It is the primary object of the present invention to provide for the simplification and improved adjustments of a spindle assembly which is mounted on the channel walls of a toggle clamp.

Another primary object is to allow for the separate vertical and horizontal adjustments with a standard diameter spindle.

A secondary object is to simplify and improve the horizontal adjustment for a channel mounted collar and associated holding member.

Another object is to provide for an improved work piece holding member that can be adjusted simply by turning a threaded bolt movable with the work piece engaging member and fixing the horizontal position by a collar locking mechanism

Still another object is to provide for the substantially reduced cost of manufacture of the adjustment mechanism.

These and other objectives and advantages of the present invention will become apparent to readers from a consideration of the ensuing description and the accompanying drawings.

### BRIEF DESCRIPTION OF THE DRAWINGS

FIG. 1 is a side view of a typical prior art spindle assembly mounted on a toggle clamp channel.

FIG. 2 is a front view of the prior art spindle assembly of FIG. 1.

FIG. 3 shows a perspective view of the present invention.

FIG. 4 depicts a front view the FIG. 3 spindle assembly mounted on the channel walls of a conventional toggle clamp channel.

FIG. 5 depicts a side view of the FIG. 4 spindle assembly as mounted on a conventional toggle clamp channel.

FIG. 6 is a perspective view of the spindle assembly by itself.

### DESCRIPTION OF THE PREFERRED EMBODIMENT

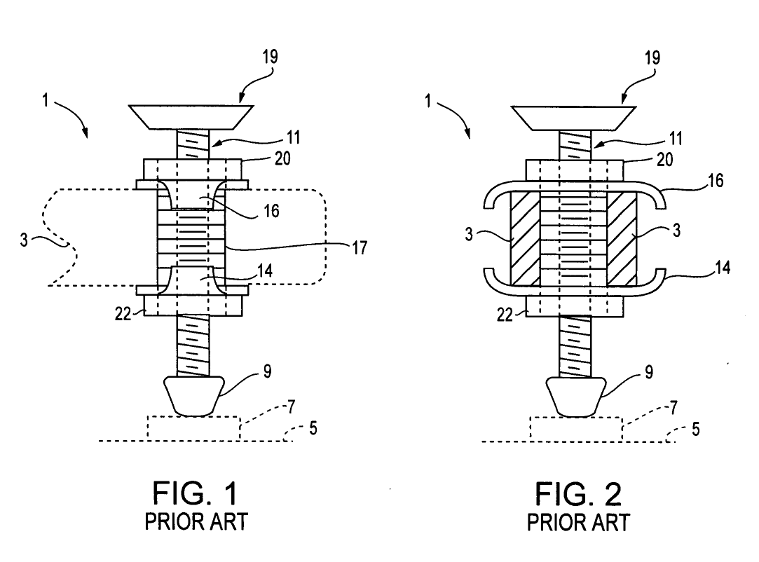

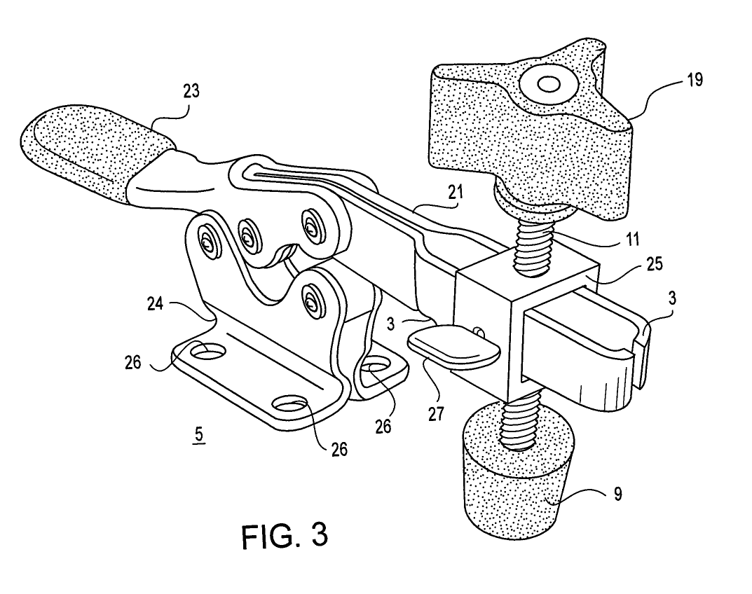

FIG. 1 is a side view of the Webb patented prior art spindle assembly 1 mounted on the channel walls 3 of a toggle clamp. The toggle clamp body, i.e., that portion of the toggle clamp not including the spindle assembly, itself, is conventional in design and may assume many different shapes, such as the body of the RED HEAD toggle action clamps manufactured by Case-Maul Clamps, Inc., Norwalk, Ohio. Accuracy and strength are essential in the design of toggle clamps since the performance of precision operations on the work piece stock, especially metal stock, requires no less. Parts that are common among the several figures have identical numbers. Examples of such common parts are the channel walls 3, the holding grommet 9, the spindle 11, the spindle handle 19, and the converged portion 21, of the two channel walls 3. The toggle clamp handle 23, see FIG. 3, is used to cause the toggle channel to compress toward the work surface when the handle is depressed to assist in holding the inserted work piece holding member of grommet 9 at the desired horizontal position relative to a work piece along the clamp channel's length. This rubber holding grommet 9 may be replaced by a metal nut, or a pivotally mounted work piece engaging metallic member, or any other work piece engaging end located at the lower end of the supporting spindle. Whatever type used for the holding grommet 9, it is essential that there be some type of channel to receive this invention's improved collar along its length. Almost any type of conventional toggle clamp body may be used with the improved spindle assembly of the present invention, including those that are restricted in length to provide for little or no horizontal adjustment of the holding member. Thus, no modifications are contemplated to the majority of conventional toggle clamp bodies insuring their ready and easy use with the present invention.

FIGS. 1-2 are essentially from the prior art Webb U.S. Pat. No. 5,924,685 (patent 685). As shown, the conventional toggle clamp is normally fixed to a lower work surface 5. A work piece 7 is held between the fixed work surface 5 and the engaging lower grommet 9 of spindle assembly 1. Fixed to the lower end of rotatable spindle 11 is grommet 9. A two piece collar consisting of pieces 14, 16 is mounted in the channel walls 3 and on spindle 11. The operation and interaction of the various components is best described in Webb patent 685. At the lower base end of collar piece 14 there is an outstanding washer piece. The vertical collar portion 17 is fixed to the lower base collar portion 14 and moves with the lower washer 14. Nut 22 is mounted on spindle 11 and engages the lower exposed portion of the unified collar piece 14,17. Turning nut 22 results in the vertical movement of the engaged unified collar. A movable upper second washer 16 rides on the spindle 11 and engages the upper nut 20 mounted on the spindle. At the top surface of the spindle 11 is the handle 19 used to rotate the spindle 11 and the lower grommet 9 in unison.

FIG. 2 is front view of the prior art spindle assembly 1 of FIG. 1 showing the channel walls 3 with two parallel walls and an open space between the walls. At the near or front end of the two walls there may be an open space or the walls may be closed at their front end. Both types of channel walls are common in the prior art. The other end of the channel walls 3 (to the left in FIG. 1) typically converge to meet a handle operated mechanism mounted on a base, which base is, in turn, mounted on the lower working surface 5. To vertically adjust the location of grommet 9 relative to the work surface and work piece, handle 19 and spindle 11 are turned. To horizontally adjust the location of the holding grommet 9 relative to the work surface 5 and work piece, nut 22 must be adjusted to permit the horizontal adjustment of the spindle assembly along the walls of channel 3. A wrench or similar tool is used to adjust nut 22.

FIG. 3 depicts a perspective view of the present invention installed on conventional channel walls 3. A handle 23 operated mechanism and toggle base 25 are shown with the present invention. Base 25 is fixed to the lower working surface 5 by screws (not shown) or other fasteners that extend into the working surface through the four (three shown) base holes 26. Parts that are conventional have the same numbers as the prior art parts mentioned in FIGS. 1-2. For example, the channel walls 3, the grommet 9, the threaded spindle 11 and the handle 19. Also, the converged end portion 21 of the two walled channel 3 is conventional. Typically, along their lengths the two walls making up the channel walls 3 are oriented above and parallel to working surface 5 and work piece. With this arrangement a user is permitted to perform operations on the work piece (here, not shown) held between the lower work surface 5 and the engaging grommet 9. Examples of the types of operations that may be performed on the work piece include cutting, welding, gluing, grinding, riveting, routing, milling, drilling, and reaming.

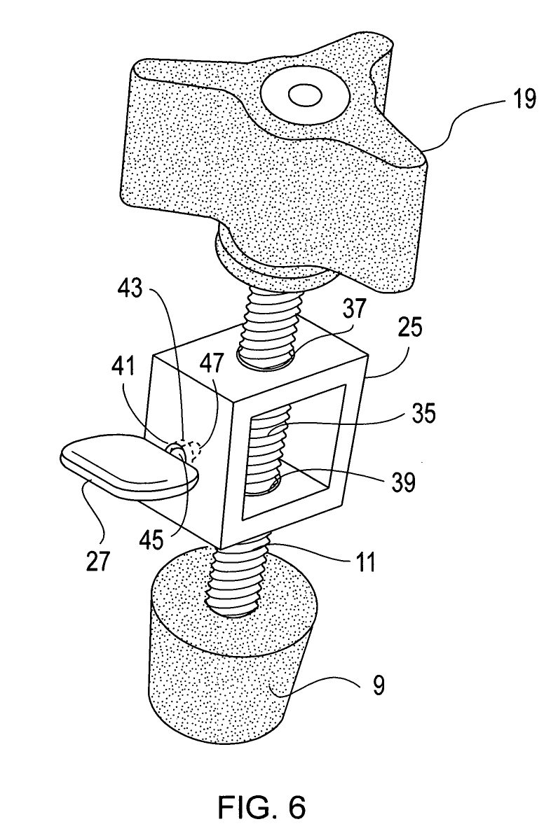

The collar 25 is mounted on the vertically disposed spindle 11. Collar 25 extends completely around the two spaced walls of channel walls 3. The collar has an opened center section with four encircling walls that form a generally rectangular configuration. Three mounting holes, as best shown in FIG. 6, extend through the collar walls from the outside into the interior open space of the collar. Spindle 11 extends through two of these aligned collar holes. Mounted on the spindle 11 are the handle 19 at one end and the grommet 9 at the other spindle end. Rotating the handle 19 moves both the spindle and attached lower grommet in unison. Mounted on one of the side collar walls is the collar locking mechanism 27.

The locking mechanism 27 is used to lock the collar to the channel walls 3. A third hole 41, see FIG. 6, in the collar acts as the mount for an extended portion of the locking mechanism 27. This third hole 41 is oriented at approximately ninety degrees from the two aligned spindle receiving holes. In the embodiment shown, a hand operated thumb screw is used as the locking mechanism 27 with a screw portion extending through a wall hole to engage one (29) of the two channel walls (29,31) that make up the channel walls 3. Internal threads in the third hole engage external threads on the inserted portion of the locking mechanism. When the tip end of the inserted locking mechanism portion firmly engages the adjacent side channel wall 29, the collar 25 is locked in place horizontally relative to the channel 3. Other types of locking mechanisms could be used to lock the collar to the channel walls. For example, a spring loaded right angled level arm could extend outward from the channel wall 29 with a section extending to and engaging the channel wall. Any device can be used that can be grasped by the user's hand/fingers and the design of which allows for the application of sufficient leverage, without the use of any tool, to effectively hold the collar in place relative to the fixed channel walls.

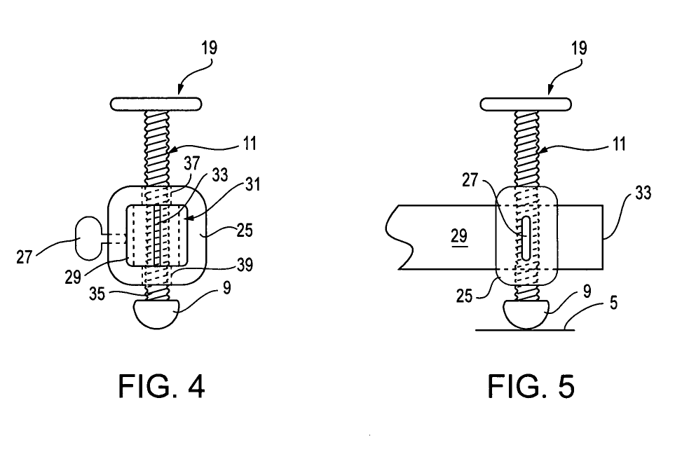

FIG. 4 depicts a front view of the FIG. 3 spindle assembly mounted on the two channel 3 walls 29, 31 of the toggle clamp. As shown, the front ends of the two channel walls 29, 31 have a slight vertically disposed opening 33 between their adjacent edges. Some conventional toggle clamps may omit such a channel opening and have the two channel walls joined together at their front ends. As is apparent from FIG. 4, the collar 25 extends completely around both of the channel walls 29, 31. The collar can slide along the length of the channel walls a predetermined distance and be locked in place by actuating the side locking mechanism 27. The collar must be very precisely machined, sized, and shaped to permit the collar's sliding movement along the channel walls while insuring a close fit that allows for minute horizontal adjustments. This configuration permits the horizontal positioning of the grommet 9 relative to the work surface 5 and a retained work piece.

The vertical movement of the grommet 9 relative to the working surface and work piece is accomplished by rotating the handle 19 attached to spindle 11. As stated before, any device can be used for the locking mechanism that can be grasped by the user's hand/fingers and whose design allows for the application of sufficient leverage, without the use of any type of tool, to effective hold the collar and work piece in place on the channel walls. Threads 35, along most, if not all, of the surface length of spindle 11, engage matching threads located within the two aligned collar holes 37,39. By decreasing the pitch of and making the collar holes and engaged spindle threads finer, very small vertical adjustments to the height of the grommet 9 relative to the fixed work surface 5 are possible. Typically, along their respective lengths the channel walls 29, 31 are parallel to each other and also the work surface 5. If desired, the orientation of the channel walls 3 can be changed to a different orientation relative to the fixed generally flat work surface 5. The holding grommet 9 is made of a soft non-marring material, like rubber, and bears against the surface of the work piece while the work surface is on the opposite work piece side. This provides a vise like arrangement to hold the work piece in place. When so positioned, various operations can be performed on the work piece.

FIG. 5 depicts a side view of the FIG. 4 spindle assembly showing the spindle assembly mounted on the two channel walls 29,31. In this view the channel wall front opening 33 is to the right and the thumb screw for the locking mechanism 27 is viewed from a side. As stated previously, the grommet 9 can be moved either vertically, horizontally or both ways relative to the working surface 5 on which the base of the toggle clamp is fixed.

FIG. 6 is a perspective view of the spindle assembly by itself. In this view the spindle assembly supporting channel walls are not shown. Spindle 11 has external threads 35 over all or much of the spindle length. The two aligned collar holes 37,39 each have matching threads to engage the threads 35 of the spindle. The soft grommet 9 is fixed to the end of the spindle and extends beyond the collar towards the work surface and work piece. At a right angle to the alignment of the spindle holes 37,39 is a third side hole 41. Hole 41 receives a portion 43 of the locking mechanism 27. There are external threads 45 are on all or some of portion 43. Threads 45 engage matching threads of hole 41. The engaging end 47 of the inserted portion 43 may extend through the collar wall hole 41 to engage and lock the collar in place relative to the adjacent channel wall 29. The four collar walls are configured in this view as being a generally rectangular ring with an opened center section.

It should be apparent that the present invention accomplishes the same functions as the Webb patent using substantially fewer parts and requiring no tools to vertically and horizontally adjust the spindle assembly. There is no need to adjust a bottom nut to achieve the desired horizontal adjustment of the spindle assembly as in the Webb patent. In using the present invention, all one needs to do is to rotate the spindle handle 19 to vertically adjust the assembly and to rotate the thumb screw locking mechanism 27 and move the collar 25 to permit horizontal adjustment.

The operation of the prior Webb patent was hampered by the fact that the diameter of the spindle needed to be reduced to accommodate the internal collar that occupied a portion of the open space of the elongated central channel of a conventional toggle clamp body. That limitation resulted in less holding power for the spindle comprised of the same metal stock. The present invention does not need to reduce the diameter of the spindle, allowing substantially increased holding power over the prior Webb patent. In fact, for toggle clamps of essentially the same size, the present invention would allow for the use of a spindle whose diameter could actually be increased over a spindle constructed according to other embodiments.

The user operates the present invention by moving the external collar horizontally along the elongated channel walls 3 until it engages favorably with the working piece 7 on the work surface 5. When that alignment is reached, the user turns the thumb screw 27 to firmly engage the channel wall. Having set the horizontal axis, the user may make the vertical adjustment to engage the work piece by turning the handle 19, which in turn turns the lower grommet 9. This action applies pressure to the work piece and the supporting work surface. The latter adjustment sets the vertical axis.

The present invention, specially the external surrounding collar 25 and its mounted parts, consists of fewer parts and is simpler and less expensive to produce, and may be totally adjusted by hand without the use of any tools, i.e. tool-less. As used in the claims the term tool-less means without the use of any tools.

Although the preferred embodiment of the present invention and the method of using the same has been described in the foregoing specification in considerable detail, it is to be understood that modifications may be made to the invention which do not exceed the scope of the appended claims and modified forms of the present invention done by others skilled in the art to which the invention pertains will be considered infringements of this invention when those modified forms fall within the claimed scope of this invention.

What I claim as my invention is:

1. The combination of a toggle clamp and spindle assembly comprising:
a toggle clamp mounted over a work surface,
said toggle clamp having spaced channel walls,
each of said channel walls having a length,
a spindle assembly mounted on said channel walls,
said spindle assembly having a collar, a spindle and locking means to lock the collar in place relative to the channel walls on which mounted,
said collar extending substantially around the channel walls and movable along the length of the channel walls,
said spindle being mounted on and extending through the collar and between the channel walls,
said locking means being mounted on the collar to lock the collar to the channel walls,
whereby a work piece engaging member may be moved in position relative to the work surface by rotating the spindle and locked into a different position by the locking mechanism.

2. The combination as claimed in claim 1, wherein said collar is slidably mounted on the channel walls and said locking means is fixed to the collar.

3. The combination as claimed in claim 2, wherein said collar has two aligned spindle receiving holes, each aligned spindle receiving hole having
internal threads and
said spindle having external threads to engage the threads in the two collar aligned spindle receiving holes.

4. The combination as claimed in claim 3, wherein said collar has a third hole to receive a portion of the locking means,
said locking means portion extending through said third hole in the collar to engage a channel wall.

5. The combination as claimed in claim 4, wherein the locking means portion extending through the third hole and has threads,
said third hole having complementary threads that engage the threads of the locking means portion that extend through the third hole.

6. The combination as claimed in claim 5, wherein
said collar has four walls that are generally shaped in a rectangular configuration with an opened center section between the four walls,
said two aligned spindle receiving holes being on opposite collar walls and said third hole being in a collar wall positioned at approximately at a right angle to the two spindle receiving aligned holes.

7. A toggle clamp and a spindle assembly comprising:
a toggle clamp having channel walls,
a spindle assembly mounted on said channel walls that extends above a work surface,
means for horizontally adjusting the position of the spindle assembly on the channel walls relative to the work surface, said means for horizontally adjusting the position of the spindle assembly being tool-less, and
means for vertically adjusting the spindle assembly relative to the work surface,
said means for vertically adjusting the spindle assembly being tool-less.

8. A method for using a toggle clamp having channel walls and a spindle assembly comprising the steps of:
mounting the spindle assembly on the channel walls of the toggle clamp with the spindle assembly extending between the channel walls, and above a work surface,
vertically positioning the spindle assembly relative to the work surface and locking the spindle assembly without the use of tools, and
horizontally positioning the spindle assembly relative to the work surface and locking the spindle assembly without the use of tools,
